(19) United States
(12) Patent Application Publication
(10) Pub. No.: US 2024/0370356 A1
(43) Pub. Date: Nov. 7, 2024

(54) TEST GENERATION APPARATUS, TEST GENERATION METHOD AND PROGRAM

(71) Applicant: NIPPON TELEGRAPH AND TELEPHONE CORPORATION, Tokyo (JP)

(72) Inventors: Shmuel UR, Galil (IL); Ziv GLAZBERG, Ramat Gan (IL); Ran LEHR, Tel-Aviv (IL); Erez KEINAN, Rishon Le-zion (IL)

(73) Assignee: NIPPON TELEGRAPH AND TELEPHONE CORPORATION, Tokyo (JP)

(21) Appl. No.: 18/562,800

(22) PCT Filed: May 27, 2021
(86) PCT No.: PCT/JP2021/020308

§ 371 Date: Nov. 20, 2023

(51) Int. Cl. G06F 11/36

(52) U.S. Cl. CPC G06F 11/3684

(57) ABSTRACT

A test generation apparatus includes: a comparison unit configured to compare an output of a test target system executed based on an input, with an output of a reference model executed based on the input; and a test generation unit configured to store the input and the output of the test target system in a storage unit, based on the result of the comparison performed by the comparison unit.

### TECHNICAL FIELD

The present invention relates to a technique for creating inputs and outputs for use in testing software.

### BACKGROUND ART

As a method of testing software, there is a method of determining whether software is normal by giving an input to the software, executing the software, and comparing the output (execution result) with an expected result. The expected result is a result to be obtained when the software is executed properly.

To reduce operations, it is desirable if software testing can be performed automatically. To create a test that can be executed automatically, it is necessary to create beforehand an input and an output that gives an expected result of the input.

Once such an input and an output are prepared, it is possible to automatically conduct a regression test for determining whether the output matches the expected result, by automatically making an input to upgraded software, for example.

### CITATION LIST

### Patent Literature

Patent Literature 1: US2014/0115565 A1

### SUMMARY OF INVENTION

### Technical Problem

Although it is relatively easy to create an input for automated testing, creating an output that gives an expected result requires a significant amount of work and therefore is not easy.

The present invention has been made in view of the foregoing, and aims to provide a technique for enabling automated creation of an input and an output for use in testing software.

### Solution to Problem

The technique disclosed herein provides a test generation apparatus that includes: a comparison unit configured to compare an output of a test target system executed based on an input, with an output of a reference model executed based on the input; and a test generation unit configured to store the input and the output of the test target system in a storage unit, based on a result of the comparison performed by the comparison unit.

### Advantageous Effects of Invention

According to the disclosed technique, it is possible to automatically create an input and an output for use in testing software.

### BRIEF DESCRIPTION OF DRAWINGS

FIG. 1 is a configuration diagram of an entire system according to an embodiment of the present invention.

FIG. 2 is a configuration diagram of a test generation apparatus.

FIG. 3 is a flowchart illustrating a process flow.

FIG. 4 is a diagram illustrating an example hardware configuration of an apparatus.

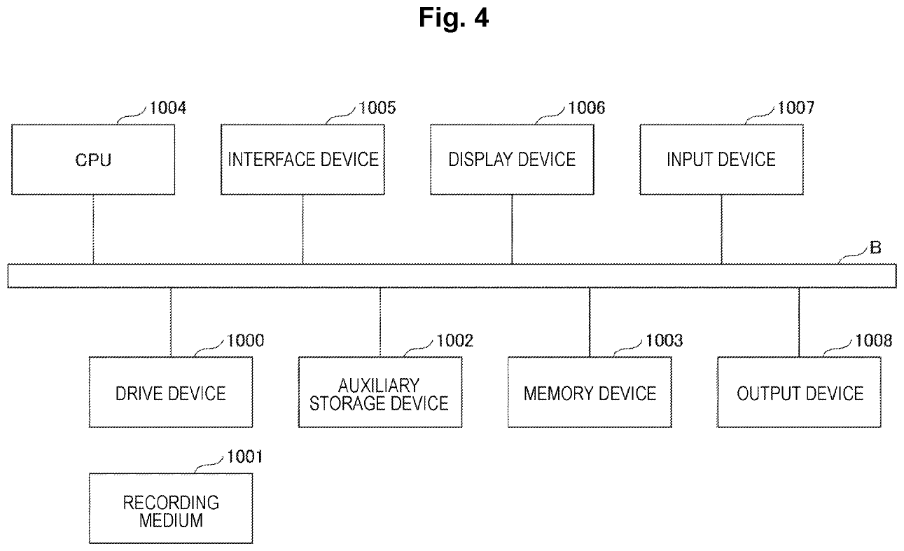

### DESCRIPTION OF EMBODIMENTS

An embodiment (the present embodiment) of the present invention will be described below with reference to the drawings. The embodiment described below is simply an example, and embodiments to which the present invention is applicable are not limited to the embodiment described below.

### Overview of an Embodiment

A test method (setup) according to the present embodiment is a common method that is used in unit tests and the like. Specifically, a code of the software to be tested is created first.

Note that, in software development, when a plurality of programming languages are developed in combination (in a mix-and-match manner), a code may be created by using a method of converting one language into another language. For example, a development method of creating a code in a high-level language and then converting the code into a code (a production code) in a low-level language may be used. When such a development method is used, there exist at least two versions of a code.

Next, a test input is created. The input may be created manually, or may be created with an automated test generator. A test is then conducted on the software to be tested and the reference model, using the test input. Note that “software” may be referred to as a “system”. That is, the software to be tested may be referred to as the “test target system”.

The result of execution by the test target system is then compared with the result of execution by the reference model, and, if these results are determined to match, the input and the output of the test are stored. The stored input and output can be used in a subsequent regression test. Note that the test to be conducted with the stored input and output is not necessarily the regression test.

That is, in the present embodiment, the input and the output for the subsequent regression test can be automatically created as byproducts of a test in the code creation process. Note that the set of the input and the output may be referred to as a “test”. In the following description, the present embodiment is explained in greater detail.

### Example System Configuration

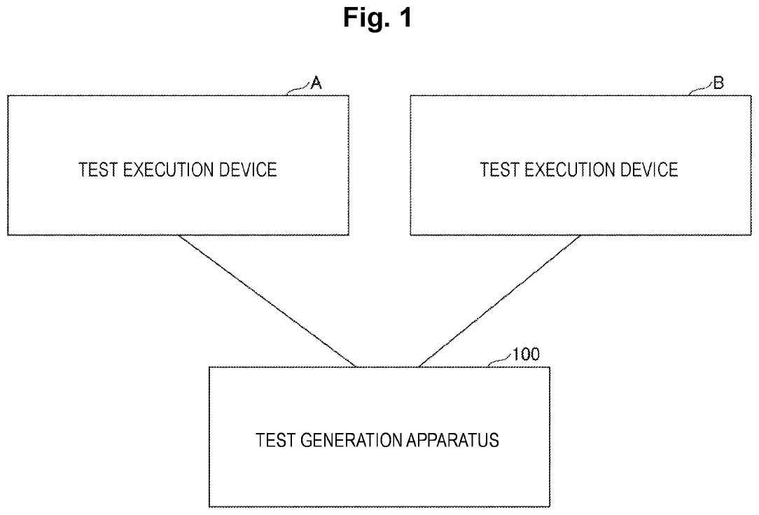

FIG. 1 illustrates an example configuration of a system according to the present embodiment. As illustrated in FIG. 1, this system includes a test execution device A, a test execution device B, and a test generation apparatus 100. The test execution device A and the test execution device B are each connected to the test generation apparatus 100 via a network.

Each of the test execution device A, the test execution device B, and the test generation apparatus 100 is a computer that is capable of executing software (programs). Each of the test execution device A, the test execution device B, and the test generation apparatus 100 may be a physical machine or a virtual machine in a cloud.

Note that, in the present embodiment, three devices are used as the test execution device A, the test execution device B, and the test generation apparatus 100, but this is simply an example. For example, one device including the functions of the test execution device A, the test execution device B, and the test generation apparatus 100 may be used.

Both the test execution device A and the test execution device B execute software using an input for a test, and output execution results. “Executing software by using an input for a test” may be referred to as a “test”.

In either of the test execution device A and the test execution device B, the software may be operated manually through an input, or may be operated automatically with a script or the like. The execution result (output) of each test conducted by the test execution device A and the test execution device B is input to the test generation apparatus 100.

The execution results that are output may include any information such as numerical values, an image of a screen, a table stored in a database, or an execution log, for example.

The test generation apparatus 100 compares the output from the test execution device A with the output from the test execution device B, determines whether the two outputs match, and stores, in accordance with the determination results, the inputs and the outputs used for the test. This operation will be described later in detail.

The present embodiment assumes that the test execution device A executes the test target system (software), and that the test execution device B executes a reference model.

The reference model is a system that is known to operate correctly (that is, derive a correct output), so that it is possible to determine whether an output of the test target system is correct by comparing the output of the test target system with the output of the reference model.

As an example, the reference model is software that operate stably before version upgrade, and the test target system is an upgraded version of software having the same functions as those of the reference model. Also, any of the codes before and after the conversion at the time of development in a mix-and-match manner may be used as reference model software.

Furthermore, there are cases where the test execution device B that executes the reference model is a terminal of a certain model that operates stably, and the test target system is software obtained by modifying the reference model for the test execution device A that is a terminal of a different model from the terminal as the test execution device B.

### Example Configuration and Example Operation of the Test Generation Apparatus

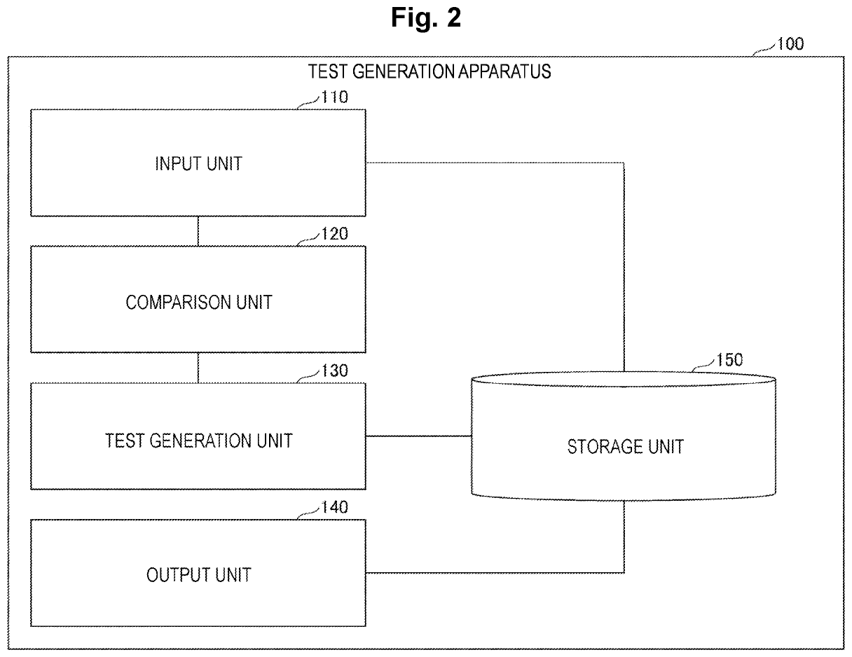

FIG. 2 illustrates an example configuration of the test generation apparatus 100. As illustrated in FIG. 2, the test generation apparatus 100 includes an input unit 110, a comparison unit 120, a test generation unit 130, an output unit 140, and a storage unit 150. Note that the storage unit 150 may be a database server that is connected to the outside of the test generation apparatus 100 via a network.

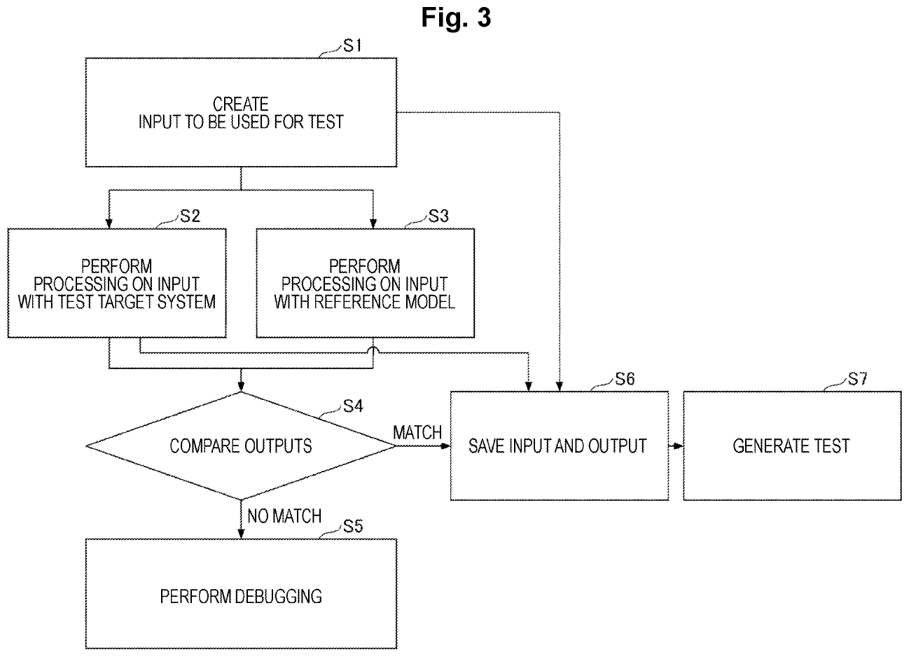

An example operation of the system including the test generation apparatus 100 is now described with reference to the flowchart shown in FIG. 3.

In the example described below, the test target system and the reference model are created in advance, and installed in the test execution devices A and B so that tests can be conducted.

### <S1 (Step 1)>

In S1, an input for a test is created. The input for a test may be a numerical value to be input to the system, procedures for an input to the system (procedures such as pressing a button A, inputting a value B, and clicking on an OK button), or some other procedures. The input for a test may be created manually, or may be created automatically.

The input for a test created in S1 is given to each of the test target system of the test execution device A and the reference model of the test execution device B.

### <S2>

In S2, the test execution device A executes the test target system based on the given input. The execution result (output) is input to the input unit 110 of the test generation apparatus 100.

### <S3>

In S3, the test execution device B executes the reference model based on the given input. The execution result (output) is input to the input unit 110 of the test generation apparatus 100.

### <S4>

In S4, the comparison unit 120 of the test generation apparatus 100 compares the output of the test target system with the output of the reference model, and determines whether these outputs match.

Regarding the determination as to whether the outputs match, it might be determined that the outputs match even if they are not exactly the same, depending on the type of the data that is output. For example, when the height of a person is output in response to a certain test input, if the test target system outputs “190 cm” while the reference model outputs “six feet three inches”, the comparison unit 120 determines that these outputs match.

In such a case, the output (190 cm) from the test target system is used as the “output” of the test to be generated, so that comparison can be easily performed in the subsequent regression test (a test for a system formed by upgrading the current test target system, for example).

Although the comparison is automatically performed by the comparison unit 120 herein, the comparison may be performed manually. For example, the comparison may be performed manually when it is difficult to perform automatic comparison, or when the match/mismatch determination cannot be performed properly through automatic comparison. When the comparison is performed manually, the person who conducted the comparison inputs the comparison result (indicating match/mismatch) to the comparison unit 120.

### <S5>

When the comparison result in S4 indicates “mismatch”, the process moves on to S5, and the test target system is debugged.

### <S6>

When the comparison result in S4 indicates “match”, the test generation unit 130 stores, in the storage unit 150, a set of the input for the test from which the result indicating “match” is obtained, and the output in response to the input. That is, a “test” including a set of an input and an output is generated.

Note that, when an output of the test target system and an output of the reference model match completely (or are exactly the same), either the output of the test target system or the output of the reference model may be used as the “output” for generating a test.

When the result of the determination by the comparison unit 120 indicates “match” and yet the outputs are not exactly the same as in the case described above, the output of the test target system may be used as the “output” for generating a test. Also, when the result of the determination by the comparison unit 120 indicates “match” and yet the outputs are not exactly the same, both the output of the test target system and the output of the reference model may be used as the “output” for generating a test.

As S1 to S6 are carried out for a plurality of tests, the storage unit 150 stores the tests in the form of “test 1={input 1, output 1}, test 2={input 2, output 2}, test 3={input 3, output 3}, . . . ”, for example.

### <S7>

In S7, the test generation unit 140 creates an automatic test (script) using the data (the input and the output) stored in S6, for example. This script executes the test target system using the input in the data stored in S6, compares the output with the output in the data stored in S6, and determine whether the two outputs match.

However, creating such a script and using the script in the regression test are only an example. The regression test can also be performed manually by using the data (the input and the output) stored in S6.

Furthermore, in the example described above, when the comparison unit 120 determines that the output of the test target system and the output of the reference model match in S6, the input and the output are stored. However, when the comparison unit 120 determines that the output of the test target system and the output of the reference model do not match, the input and the output of the test target system may be stored. The data stored data in this case may be used in the subsequent regression test, so that it is possible to conduct a test to check whether the output in response to the input is different from the output of the stored data and is a correct result.

Also, when the comparison unit 120 determines that the output of the test target system and the output of the reference model match, the input and the output of the test target system may be stored together with information indicating “match”. When the comparison unit 120 determines that the output of the test target system and the output of the reference model do not match, the input and the output of the test target system may be stored together with information indicating “mismatch”.

### Example Hardware Configuration

The test generation apparatus 100 can be formed with a computer caused to execute programs, for example. This computer may be a physical computer, or may be a virtual machine in a cloud.

To be more specific, the test generation apparatus 100 can be formed with a computer that executes programs corresponding to the processing performed in the test generation apparatus 100, using hardware resources such as a CPU and a memory built in the computer. The above programs are recorded in a computer-readable recording medium (such as a portable memory) so that the programs can be stored and distributed. Also, the programs can be provided through a network such as the Internet or electronic mail.

FIG. 6 is a diagram illustrating an example hardware configuration of the computer. The computer in FIG. 6 includes a drive device 1000, an auxiliary storage device 1002, a memory device 1003, a CPU 1004, an interface device 1005, a display device 1006, an input device 1007, and an output device 1008, which are connected with one another by a bus BS.

The programs for implementing processing in the computer are provided through a recording medium 1001 such as a CD-ROM or a memory card, for example. When the recording medium 1001 that stores the programs is set in the drive device 1000, the programs are installed from the recording medium 1001 into the auxiliary storage device 1002 via the drive device 1000. However, the programs do not necessarily have to be installed from the recording medium 1001, and may be downloaded from another computer via a network. The auxiliary storage device 1002 stores the installed programs, and also stores necessary files, data, and the like.

When a command to start a program is issued, the memory device 1003 reads the program from the auxiliary storage device 1002, and stores the program therein. The CPU 1004 implements the functions related to the test generation apparatus 100, in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, buttons, a touch panel, or the like, and is used to input various operation commands. The output device 1008 outputs a calculation result.

### Effects of the Embodiment

As described above, according to the technique of the present embodiment, it is possible to automatically create inputs and outputs for use in testing software. In particular, according to the technique of the present embodiment, it is possible to automatically create inputs and outputs that are suitable for a regression test for maintenance after software development as byproducts of the test.

### SUMMARY OF THE EMBODIMENT

The present specification discloses at least the test generation apparatus, the test generation method, and the program described in the following items.

### (Item 1)

A test generation apparatus including: a comparison unit configured to compare an output of a test target system executed based on an input, with an output of a reference model executed based on the input; and a test generation unit configured to store the input and the output of the test target system in a storage unit, based on a result of the comparison performed by the comparison unit.

### (Item 2)

The test generation apparatus according to item 1, wherein, when the comparison unit determines that the output of the test target system and the output of the reference model match, the test generation unit stores the input and the output of the test target system in the storage unit.

### (Item 3)

The test generation apparatus according to item 1 or 2, wherein, when the comparison unit determines that the output of the test target system and the output of the reference model do not match, the test generation unit stores the input and the output of the test target system in the storage unit.

### (Item 4)

A test generation method implemented by a computer, the test generation method including: comparing an output of a test target system executed based on an input, with an output of a reference model executed based on the input; and storing the input and the output of the test target system in a storage unit, based on a result of the comparison.

### (Item 5)

A program for causing a computer to function as the comparison unit and the test generation unit in the test generation apparatus of any one of items 1 to 3.

Although the present embodiment has been described above, the present invention is not limited to such a specific embodiment, and various modifications and changes can be made within the scope of the present invention disclosed in the claims.

### REFERENCE SIGNS LIST

A, B test execution device
100 test generation apparatus
110 input unit
120 comparison unit
130 test generation unit
140 output unit
150 storage unit
1000 drive device
1001 recording medium
1002 auxiliary storage device
1003 memory device
1004 CPU
1005 interface device
1006 display device
1007 input device

1. A test generation apparatus comprising:
a comparison unit configured to compare an output of a test target system executed based on an input, with an output of a reference model executed based on the input; and
a test generation unit configured to store the input and the output of the test target system in a storage unit, based on a result of the comparison performed by the comparison unit.

2. The test generation apparatus according to claim 1, wherein, when the comparison unit determines that the output of the test target system and the output of the reference model match, the test generation unit stores the input and the output of the test target system in the storage unit.

3. The test generation apparatus according to claim 1, wherein, when the comparison unit determines that the output of the test target system and the output of the reference model do not match, the test generation unit stores the input and the output of the test target system in the storage unit.

4. A test generation method implemented by a computer, the test generation method comprising:
comparing an output of a test target system executed based on an input, with an output of a reference model executed based on the input; and
storing the input and the output of the test target system in a storage unit, based on a result of the comparison.

5. A non-transitory computer-readable recording medium storing a program that, when executed on a computer, causes the computer to function as the comparison unit and the test generation unit in the test generation apparatus of claim 1.
